(19) United States
(12) Patent Application Publication
(10) Pub. No.: US 2026/0280788 A1
(43) Pub. Date: Sep. 17, 2026

(54) HYBRID AUTOMATIC REPEAT REQUEST PROCESS DETERMINATION

(71) Applicant: Apple Inc., Cupertino, CA (US)

(72) Inventors: Fangli Xu, Beijing (CN); Ping-Heng Kuo, London (GB); Ralf Rossbach, Munich (DE); Peng Cheng, Beijing (CN); Sethuraman Gurumoorthy, San Ramon, CA (US); Haijing Hu, Los Gatos, CA (US); Zhibin Wu, Los Gatos, CA (US); Naveen Kumar R. Palle Venkata, San Diego, CA (US); Alexander Sirotkin, Tel Aviv (IL)

(73) Assignee: Apple Inc., Cupertino, CA (US)

(21) Appl. No.: 19/472,629

(22) PCT Filed: Apr. 5, 2023
(86) PCT No.: PCT/CN2023/086346

§ 371 Date: Oct. 3, 2025

(51) Int. Cl. H04L 5/00; H04L 1/1867

(52) U.S. Cl. CPC H04L 5/0044; H04L 1/1896

(57) ABSTRACT

Techniques for flexible hybrid automatic repeat request selection by a user equipment are provided. An example method includes a user equipment (UE) detecting a set of physical uplink shared channel (PUSCH) opportunities within a configured grant cycle. The UE can associate a first hybrid automatic repeat request (HARQ) process identifier (PID) setting with a first PUSCH opportunity of a first subset of the set of PUSCH opportunities, the first HARQ PID setting configured by a base station. The UE can select a second HARQ PID setting for a second PUSCH opportunity of a second subset of the set of PUSCH opportunities.

### TECHNICAL FIELD

This application generally relates to wireless communication, and in particular relates to hybrid automatic repeat request process determination.

### BACKGROUND

Cellular communications can be defined in various standards to enable communications between a user equipment and a cellular network. For example, long-term evolution (LTE) and Fifth generation (5G) networks are defined by wireless standards that aim to improve upon data transmission speed, reliability, availability, and more.

### BRIEF DESCRIPTION OF THE DRAWINGS

FIG. 1 is an illustration of a system for providing content to a user equipment (UE), according to one or more embodiments.

FIG. 2 is an illustration of a payload periodic traffic pattern, according to one or more embodiments.

FIG. 3 is an illustration of a periodic configured grant (CG) configuration, according to one or more embodiments.

FIG. 4 is an illustration of varying data packets sizes, according to one or more embodiments.

FIG. 5 is an illustration of multi-physical uplink secure channel (PUSCH) opportunities, according to one or more embodiments.

FIG. 6 is an illustration describing used and unused PUSCH opportunities, according to one or more embodiments.

FIG. 7 is an illustration of a set of PUSCH opportunities, according to one or more embodiments.

FIG. 8 is an illustration of sets of PUSCH opportunities, according to one or more embodiments.

FIG. 9 is a process flow for selecting a hybrid automatic repeat request (HARQ) process identifier (PID) setting, according to one or more embodiments.

FIG. 10 is a process flow for a UE selecting a HARQ PID setting, according to one or more embodiments.

FIG. 11 is a process flow for a UE selecting a HARQ PID setting, according to one or more embodiments.

FIG. 12 illustrates an example of receive components, in accordance with some embodiments.

FIG. 13 illustrates an example of a user equipment (UE), in accordance with some embodiments.

FIG. 14 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, and/or 6G. In general, 3GPP access refers to various types of cellular access technologies.

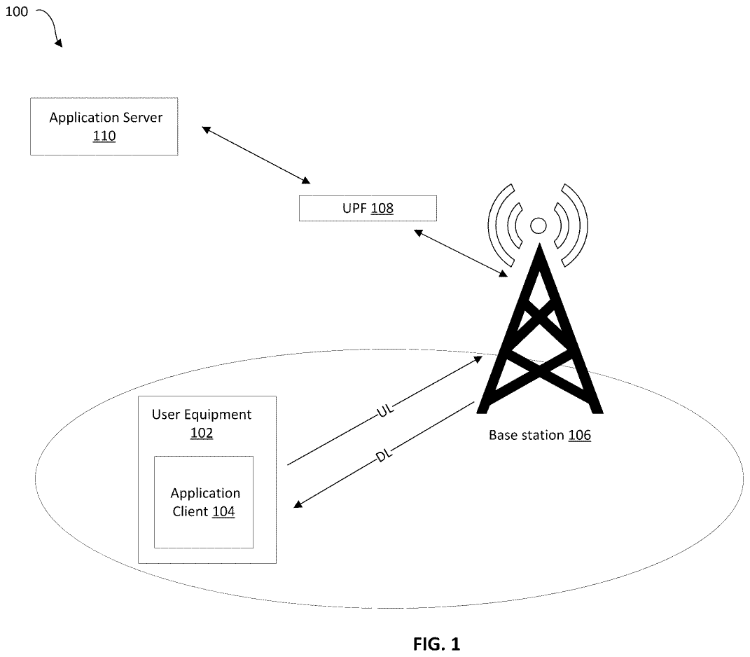

FIG. 1 is an illustration of a system for providing content to a user equipment (UE), according to one or more embodiments. As illustrated, a UE 102 can include a client application 104 for providing a user with an experience. For example, the user can use the client application 104 to transmit (e.g., uplink (UL) communication) and receive (e.g., downlink (DL) communication) content and to present the content on the UE 102. The UE 102 can be camped in a cell provided by a base station 106. The base station 106 can, for example, use a user plane function (UPF) 108 to communicate with an external data network, such as one that includes an application server 110. The UE 102 can exchange information with the application server 110 to provide a user with an experience.

The base station 106 can use a configured grant (CG) to configure the UE 102 with uplink transmission parameters to transmit data to the base station 106. Through the CG, the UE 102 is allocated resources for periodic physical uplink shared channel (PUSCH) opportunities, in which the UE can transmit multiple PUSCH transmissions in each CG cycle. For example, the UE 102 can be configured to with the opportunity to transmit x-number of PUSCH transmission in each CG cycle.

Certain data traffic patterns can include variations in data packet sizes based on the technology and the type of data that is being transmitted. One example of such technology is extended reality (XR) technology. XR includes several technologies including virtual reality (VR), augmented reality (AR), and mixed reality (MR). For optimal performance and user experience, XR technologies require high-speed and reliable data transfer. Certain XR experiences can be downloaded and enjoyed locally on a device. Other XR experiences can be streamed from a cloud computing environment. For example, in some instances, the XR technology is based on overlaying graphics on an image which may be performed using smaller packets. On the other hand, an immersive XR experience can use high resolution graphics and location data, which requires larger packets.

Given the different data packet sizes, it is possible that the UE 102 uses all of the PUSCH opportunities in a CG cycle. However, in other instances, the UE can only use a portion of the PUSCH opportunities in the CG cycle. In these instances, some PUSCH opportunities can be unused. One reason that the UE 102 is unable to use these “spare” opportunities is because the hybrid automatic repeat request (HARQ) processes for each PUSCH opportunity are preset and fixed based on network configuration. Therefore, it would be beneficial if the UE 102 can select the HARQ process and use these spare PUSCH opportunities for other purposes during the CG cycle.

It should be appreciated that XR technology is illustrated as an example of a technology that can result in data traffic patterns that include varying data packet sizes. Those having ordinary skill in the art can contemplate various technologies that can result in data traffic patterns that include varying data packet sizes.

The herein-described embodiments, address the above-referenced issues by providing technologies to allow the UE select hybrid automatic repeat request (HARQ) process identifier (PID) settings to use spare PUSCH opportunities for purposes other than intended for by the CG. A set of PUSCH opportunities can be partitioned into a first subset and a second subset, wherein the first subset includes the PUSCH opportunities to be used to transmit data based on the original purpose (e.g., to perform new transmission for data from specific logical channels (LCHs), this can be enabled by LCH mapping restriction with allowed CG). The HARQ PID setting for the PUSCH opportunities of the first subset can configured by the base station. The second subset can include PUSCH opportunities to be used for alternative purposes, such as performing a retransmission of a previously transmitted transport block (TB), performing an autonomous transmission of a previously de-prioritized TB, or performing a new initial transmission. To allow the UE to use the second subset for alternative purposes, the UE can be enabled to set the HARQ PID settings for the PUSCH opportunities of the second subset.

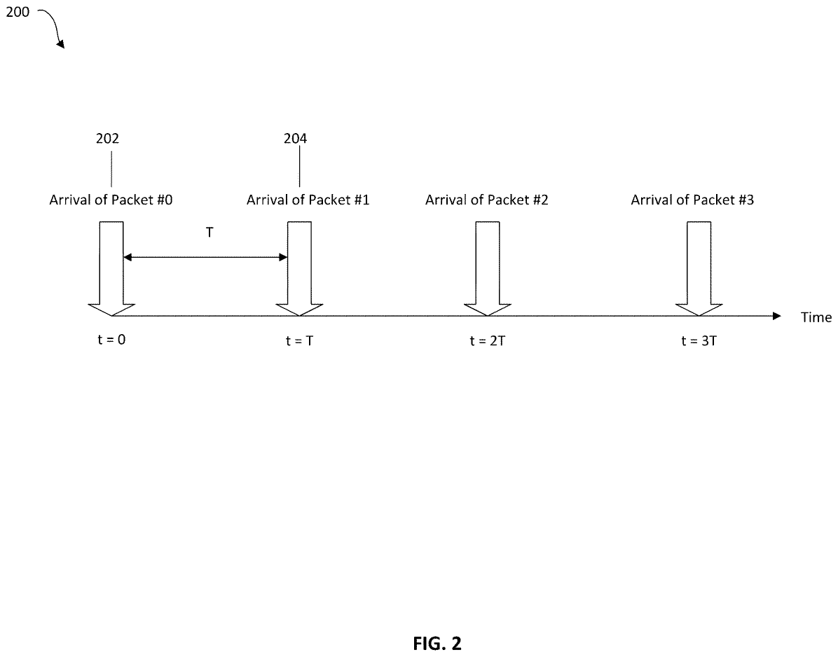

FIG. 2 is an illustration of a payload periodic traffic pattern, according to one or more embodiments. For both the DL transmission and the UL transmission of XR services, the payload is periodical. For example, in an XR service, the video frame rate can be 30 frames per second, 60 frames per second, or 90 frames per second. As illustrated, the arrival of each packet is periodical, in which each period can be defined by the frequency 1/T. The arrival of a first packet 202 can be followed by the arrival of a second packet 204, and so on. The arrival time of each packet is separated by time period T.

In an ideal situation, the radio access network (RAN) can obtain assistance information relating to the characteristics of the data traffic from either the core network or the UE. The RAN could further use such assistance information to appropriately allocate resources for the services. Based on the periodic nature of the data traffic, the CG can be expected to be a key resource allocation method for new transmission of data of specific UL traffic flow. However, as indicated above, in some instances, resources are allocated for PUSCH opportunities that are unused for new transmission for specific UL traffic flow, but could be used for alternative purposes if the UE could select the corresponding HARQ PID setting.

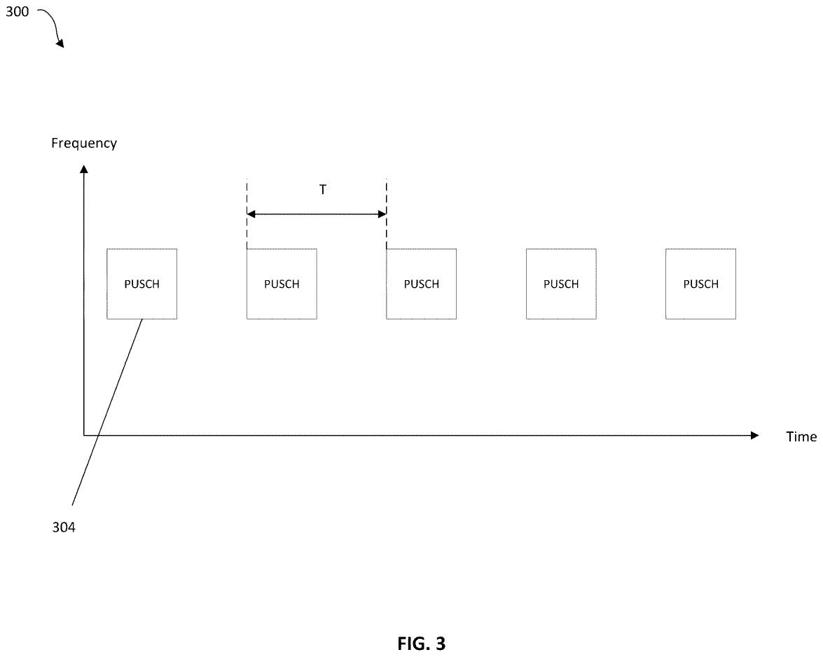

FIG. 3 is an illustration 300 of a periodic CG configuration, according to one or more embodiments. The CG permits the UE to know in advance where, in the time and frequency range, that the PUSCH resources are available for an UL transmission, without the need for dynamic signaling for resource allocation. As illustrated, a CG configuration with a periodicity of T is shown. For each PUSCH opportunity 304, the UE (e.g., UE 102) can receive information from the network configurations for the resources that are allocated for a UL transmission during the PUSCH opportunity. As further illustrated, the CG is used to allocate resources for each PUSCH opportunity per CG cycle, where each CG cycle can be defined by a time period T.

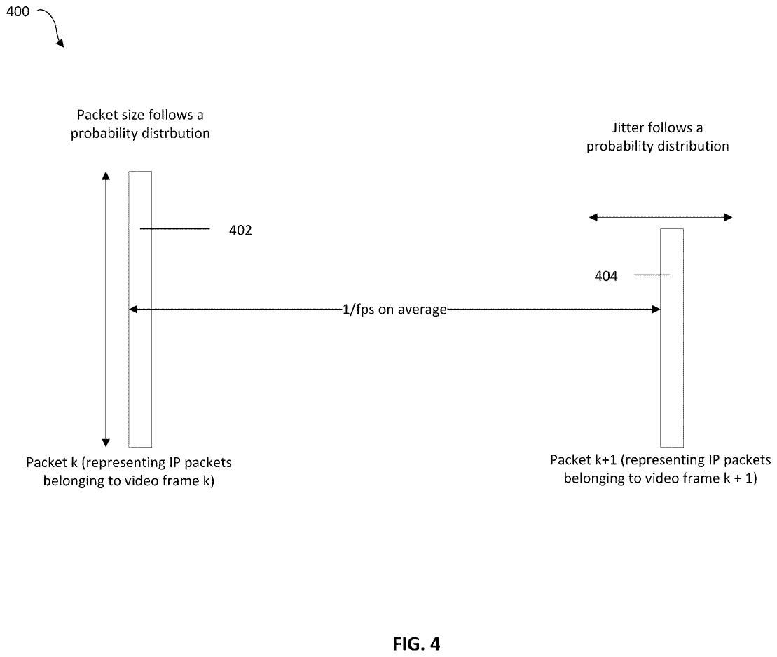

FIG. 4 is an illustration of varying data packet sizes, according to one or more embodiments. As illustrated, a packet k 402 is followed by a packet k+1. Packet k 402 represents internet protocol (IP) packets belong to video frame k and packet k+1 404 represents IP packets belonging to video frame k+1. According to 3GPP Technical report (TR) 38.838, an XR periodic traffic can be associated with random jitter, where the actual arrival time may be offset from the nominal timing, based on traffic periodicity. As illustrated, the data traffic packets can be transmitted at 1 frame per second (fps) on average based on an expected jitter. In addition to variations in timing, there are variations in packet size. As illustrated, packet k 402 is larger than packet k+1 404. It is possible that the traffic characteristics will be addressed in release-18. There can be different situations involving varying packet sizes with a fixed transport block size (TBS). A first situation can be when the packet size is larger than the TBS of a CGS occasion. Therefore, the packet cannot be accommodated with one CG cycle, which can cause latency. The second situation can be when the packet size is smaller than the TBS of CG occasion, which is not resource efficient. Furthermore, in this second situation, the base station could have allocated resources to another UE.

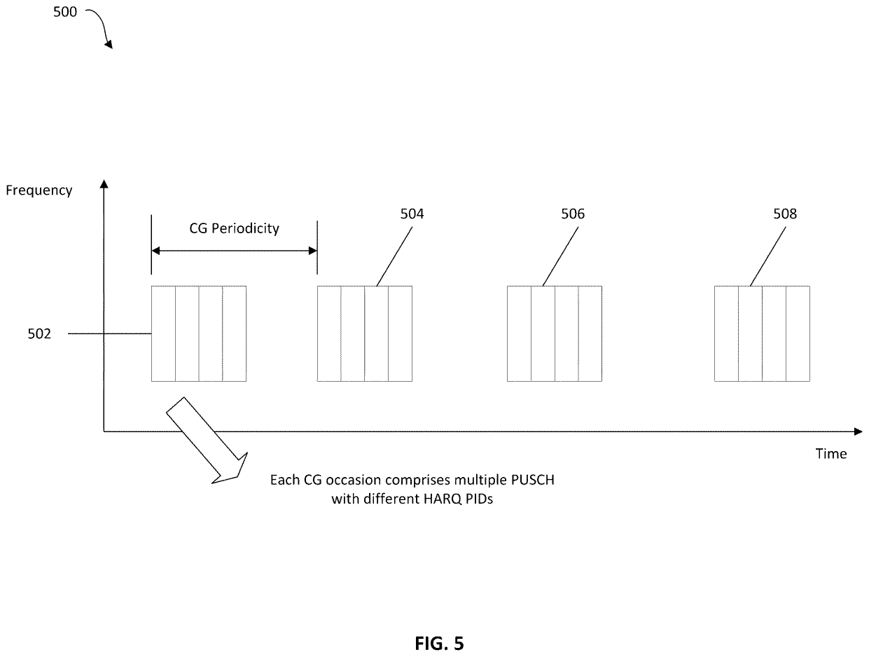

FIG. 5 is an illustration 500 of multi-PUSCH opportunities, according to one or more embodiments. As illustrated, each CG occasion includes a set of multi-PUSCH opportunities, in which each set includes four PUSCH opportunities. It be seen that each of the first set of PUSCH opportunities 502, the second set of PUSCH opportunities 504, the third set of PUSCH opportunities 506, and the fourth set of PUSCH opportunities 508 includes four PUSCH opportunities. The periodicity of each set of PUSCH opportunities in a CG occasion extends from the beginning of a first PUSCH opportunities of the first set of PUSCH opportunities 502 to the beginning of a first PUSCH opportunities of the second set of PUSCH opportunities 504. As described herein multi-PUSCH opportunities indicate more than one PUSCH opportunity.

For each CG occasion, the set of PUSCH opportunities can include PUSCH opportunities associated with different HARQ PIDs. There are different HARQ processes that can be used for each PUSCH opportunity. HARQ is a method used to improve the reliability of data transmission by retransmitting lost or corrupted packets. The HARQ process identifier is a unique identifier assigned to each transmission attempt in a HARQ process.

A UE can transmit UL data in the form of transport blocks (TBs). After each UL transmission attempt, the base station can try to decode the TB. If the TB is decoded successfully by the base station, the base station may send an acknowledgement (ACK) to the UE to indicate that the packet was received correctly. If, however, the TB is not decoded successfully by the base station, the base station can schedule a retransmission grant for the UE to retransmit the packet.

The UE and the base station can use a HARQ process identifier (HARQ PID) to identify each transmission attempt within a CG cycle. The HARQ PID is used to keep track of the different TBs that are transmitted and retransmitted. For example, if the UE receives a retransmission grant from the base station, the UE can use the HARQ PID to identify which TB needs to be retransmitted.

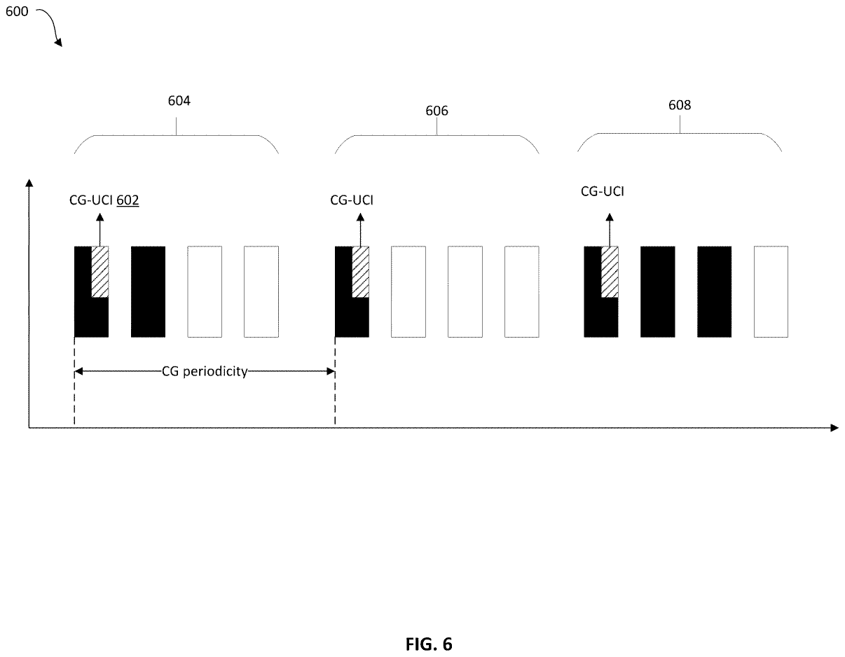

FIG. 6 is an illustration 600 describing used and unused PUSCH opportunities, according to one or more embodiments. As indicated above, in certain instances, the UE's uplink data traffic includes varying packet sizes, and therefore, the UE does not need to every single PUSCH opportunity in a CG cycle. In these instances, there will be unused PUSCH opportunities or spare PUSCH opportunities. In release-18, the UE can send an indication (e.g., in CG-UCI) 602 to a base station as to which PUSCH opportunities that are not to be used, and therefore the base station can allocate the resources allocated for those PUSCH opportunities to other UEs. As illustrated, for each set of PUSCH opportunities, there can be a different number of used and unused PUSCH opportunities. In the first set of PUSCH opportunities 604, there are two used PUSCH opportunities (illustrated in black) and two unused PUSCH opportunities (illustrated in white). In the second set of PUSCH opportunities 606, there is one used PUSCH opportunity and three unused PUSCH opportunities. In the third set of PUSCH opportunities 608, there are three used PUSCH opportunities and one unused PUSCH opportunity.

The embodiments described herein provide greater flexibility, by letting the UE use these spare PUSCH opportunities for various purposes, such as performing retransmission of a previously transmitted TB autonomously (without the need of retransmission grant from the base station), perform autonomous transmission of a previously de-prioritized TB, and performing a new initial transmission. These various purposes could not be performed by the UE under the existing framework, because the HARQ processes for each PUSCH within the CG cycle is fixed.

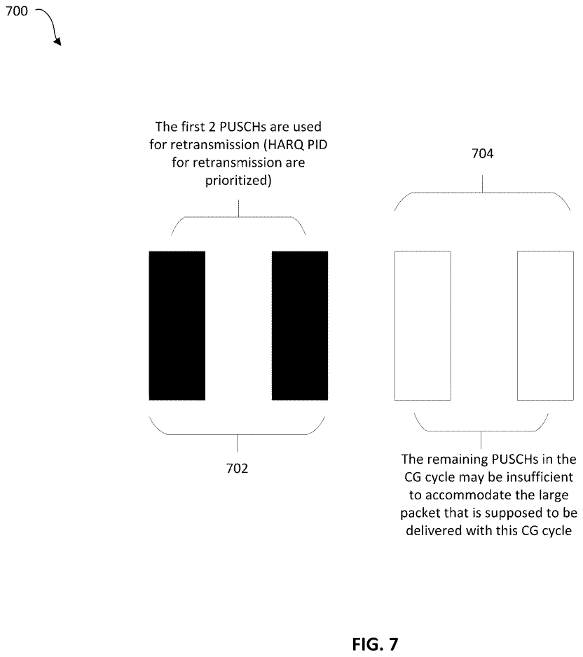

FIG. 7 is an illustration of a set of PUSCH opportunities, according to one or more embodiments. For NR operation using an unlicensed spectrum, the UE can select the HARQ PID for a CG resource by itself (e.g., from a configured HARQ PID pool). However, in the event that the UE selects a HARQ PID for a CG PUSCH opportunity, according the current MAC specification the UE should prioritize HARQ PID corresponding to a retransmission. For example, the UE should have some TBs stored in certain HARQ processes. The UE should first select the HARQ processes corresponding to retransmission, instead of a HARQ process corresponding to a new transmission.

However, if a new radio-unlicensed (NR-U) mechanism is applied to a multi-PUSCH CG for XR, the first one or more PUSCH opportunities for a CG cycle may be used by the UE for retransmission (based on the prioritization rules mentioned above), and the remaining available PUSCH resources in the CG cycle may not be sufficient to accommodate a large packet size, and the UE may need to wait until the next CG cycle to completely transmit this large packet, which may lead to undesirable latency. As seen in FIG. 7, the first two spare PUSCH opportunities 702 are used for retransmissions. The remaining two spare PUSCH opportunities 704 are insufficient to accommodate a large data packet.

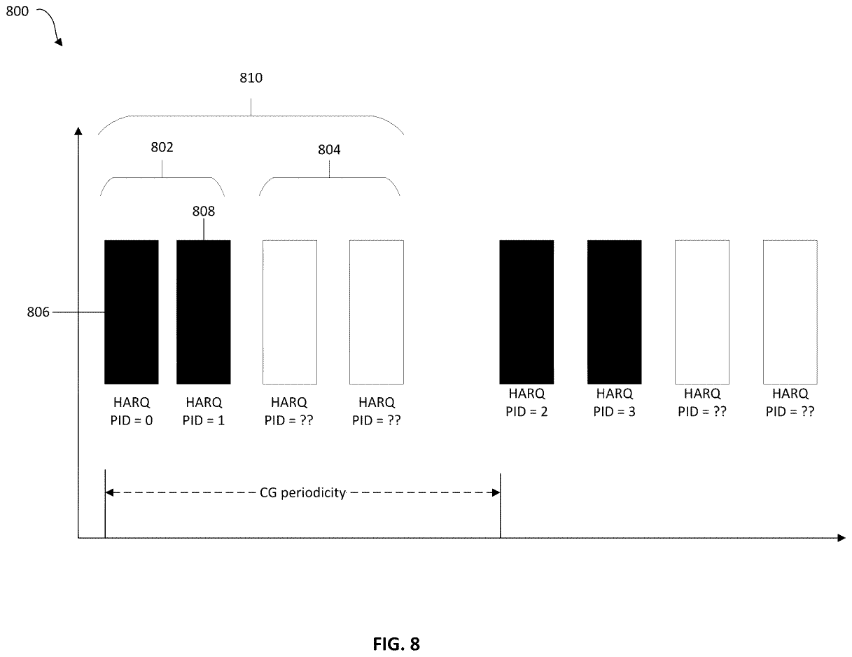

FIG. 8 is an illustration 800 of sets of PUSCH opportunities, according to one or more embodiments. Embodiments herein-described a methodology for enabling a UE to use a spare PUSCH resource with a multi-PUSCH CG and improve resource efficiency. A base station can use a configuration message to allocate resources for N number of PUSCH opportunities in a CG cycle. Each set of PUSCH opportunities in a CG cycle can be partitioned into a first subset 802 and a second subset 804. The first subset 802 can include K (K<N) PUSCH opportunities whose HARQ PIDS are fixed. For example, the HARQ PIDs can be based on resource timing as in existing technical standards including 3GPP TS 38.321.

As illustrated, a first PUSCH opportunity 806 is fixed with a HARQ PID 0, and a second PUSCH opportunity 808 is fixed with a HARQ PID 1. Each PUSCH opportunities on the second subset 804 has not been fixed with any HARQ PID. The second subset 804 includes PUSCH opportunities whose HARQ PID is selectable by the UE. It should be appreciated the HARQ PID 0 and HARQ PID 1 are placeholder values and the PUSCH opportunities of a subset should not be construed as being fixed with particular HARQ PIDs. A second set of PUSCH opportunities follows the first set of PUSCH opportunities, in which the second set of PUSCH opportunities have also been partitioned into a first subset PUSCH opportunities with fixed HARQ PIDs and a second subset of PUSCH opportunities, whose respective HARQ PIDs are selectable by the UE. It should be appreciated that the herein-described embodiments are applicable to a CG and a multi-PUSCH dynamic grant (DG), wherein the DG allocates multiple PUSCH resources.

A set of PUSCH opportunities in a CG cycle (e.g., the first set of PUSCH opportunities 810) can be partitioned into the first subset 802 and the second subset 804 based on a fixed partitioning or a dynamic partitioning. Fixed partitioning includes the network pre-configuring the first subset 802 and the second subset 804. For fixed partitioning, the first subset 802 and the second subset 804 are fixed. Therefore, the UE is preconfigured to identify which PUSCH belongs in the first subset 802 and which PUSCH opportunities belong in the second subset 804. Note that in some embodiments the PUSCH opportunities in the first subset 802 can occur after the PUSCH opportunities in the second subset 804.

For dynamic partitioning, the partitioning can be based on the number of PUSCH opportunities that the UE is going to use for the transmission of data from specific logical channels (LCHs). In the instances that the UE transmits all of the data intended to be transmitted in a set of PUSCH opportunities (i.e., data from specific LCHs), the UL transmission buffer of one or more LCHs can be considered empty. Upon detecting that such buffer is empty, the UE can determine whether there are any spare PUSCH opportunities in the CG cycle. If there are one or more spare PUSCH opportunities, the UE can determine that those PUSCH opportunities are in the second subset 804. These spare PUSCH opportunities may have their original or default HARQ PIDs pre-configured by the base station, but the UE may select alternative HARQ PIDs (which replace the original or default HARQ PIDs) for these PUSCH opportunities if they are considered as spare PUSCH opportunities (e.g. not to be used for data from specific LCHs, as the UL transmission buffer of these LCHs are considered empty).

In instances of periodic traffic, such as XR traffic, the HARQ process of the first PUSCH opportunity (e.g., PUSCH opportunity 806 should be a static configuration by the base station to make sure that the UE can perform a new initial UL transmission for an intended purpose (e.g. to perform new transmission of data from specific LCHs) transmission before selecting a HARQ process for an UL transmission used from another purpose (e.g. to perform retransmission of a previously transmitted TB).

In some instances, the UE can select an allowed HARQ process for a PUSCH opportunity in the second subset from a pool of HARQ PIDs for a particular CG. In these instances, the base station can pre-configure the allowed HARQ PID pool for each CG. The UE is only permitted to select a HARQ PID from the pre-configured pool associated with the CG when processing the PUSCH in the second subset. The base station can configure the UE with the allowed HARQ PID pool using an RRC parameter (or the extension of which) of harq-ProcID-Offset in the information element (IE) of ConfiguredGrantConfig.

In some instances, the base station configures a DG to allocate resources for the set of PUSCH opportunities. In these instances, the base station can further indicate whether the UE is to use fixed partitioning or dynamic partitioning to determine how to partition the set of PUSCH opportunities in the CG cycle using the DCI that allocated the DG.

In instances that the UE is configured to use direct partitioning, the UE can be configured to include a different number of PUSCH opportunities in the first subset for each CG cycle. For example, the UE can be configured to include two PUSCH opportunities in the first subset on a first CG cycle. The UE can further be configured to include three PUSCH opportunities in the first subset in a subsequent CG cycle.

To effectuate the UE selecting HARQ PIDs for the second subset of PUSCH opportunities in a CG cycle, the base station and UE synchronize which HARQ PID has been selected for which PUSCH opportunity.

The base station can use a configuration message to configure a UE with resources for sets of PUSCH opportunities for multiple CG cycles. The base station can further configure the UE for multiple instances of direction partitioning and/or multiple instances of dynamic partitioning during the multiple CG cycles. The UE can transmit one or more UL messages/control signals to indicate at least one of the following (1) whether the UE is going to use a spare PUSCH opportunity for a purpose other than the purpose of the PUSCH opportunities in the first subset; (2) in the event the base station has configured the UE with PUSCH resources using a DG, which PUSCH opportunity is to be considered as the “second subset” where the UE would select the HARQ PID by itself; and (3) what are the HARQ PIDs to be selected by the UE for each PUSCH in the second subset. The UE can transmit the UL messages/uplink control signals to the base station using UCI, CG-UCI, or a medium access control control element (MAC CE).

The UE can transmit one or more uplink messages/control signals in one or more of the PUSCHs within the concerned CG cycle. In other words, the CG cycle within with the UE is going to select a HARQ PID for a PUSCH opportunity. For example, the UE can transmit CG-UCI, to the base station, in the first PUSCH of the CG cycle (e.g., the first PUSCH of the first subset), where the CG-UCI that includes an indication as what HARQ PID is selected by the UE for all subsequent PUSCHs in the second subset. Alternatively, the UE can transmit CG-UCI to the base station that includes an indication of whether the UE is going to use or skip the PUSCH resources in the second subset. Yet another alternative can include the UE transmitting CG-UCI indicating the selected HARQ PID in the corresponding PUSCH in the second subset.

If fixed partitioning is used, the UE may elect not to send any CG-UCI in and PUSCH resource in the first subset. The base station having already partitioned the first subset and the second subset, knows the HARQ PIDs of the first subset.

As indicated above, the UE can select a HARQ PID for the spare PUSCH opportunities in the second subset of PUSCH opportunities in the CG cycle. The UE can be configured to select a HARQ PID for a spare PUSCH opportunity using various criteria.

For example, the UE can select a HARQ process that the same HARQ process as corresponding to an earlier PUSCH in the same CG cycle. The UE can make this selection to, for example, perform a repetition of transmitting the transport block that was transmitted on the earlier PUSCH in the same CG cycle. For example, to proactively improve the reliability.

In another example, the UE can select a HARQ process that the same HARQ process as corresponding to an earlier PUSCH in either a previous CG cycle or the same CG cycle, where the configured grant timer associated to the HARQ process is still running. The configured grant timer controls how long should the UE keep a TB in a HARQ process before flushing. Similar to above, the UE can choose to select the same HARQ PID based on needing to retransmit the TB that is still stored in a HARQ buffer.

In some instances, the UE can select a HARQ process, in which an associated configured grant timer is not running, in order to perform a new transmission. The examples in the above-described situations in which the UE is retransmitting a previously transmitted TB. However, in many instances, the UE may need to transmit a new TB rather than retransmit a previously transmitted TB. Therefore, after a configured grant timer associated with a previous PUSCH has expired, the UE can select a HARQ PID for transmitting a new transmission.

In another example, the UE can select a HARQ process that is the same as the HARQ process of an earlier PUSCH in a previous CG cycle or the same CG cycle. However, a MAC protocol data unit (PDU) being transmitted using the PUSCH resources has been de-prioritized. Note that a MAC PDU may be equivalent to a TB. A MAC DPU can be de-prioritized based on a desire to allow higher priority MAC PDUs to be transmitted first, such as in times of high traffic. The de-prioritized MAC PDU, which has not been transmitted completely, can be transmitted in a subsequent resource based on autonomous transmission mechanism. Hence, when there is a spare PUSCH, the UE may select the HARQ process corresponding to a de-prioritized MAC PDU to perform an autonomous transmission of the de-prioritized MAC PDU.

In any of the above-described examples, the UE can take into account the LCH priority of the MAC PDUs corresponding to different HARQ processes. For example, the UE can select the HARQ process that corresponds to the purposes of transmitting the MAC PDU with the highest LCH priority.

A base station (e.g., the base station 106 of FIG. 1) can configure a UE (e.g., the UE 102 of FIG. 1) as to how to handle the spare PUSCH opportunities of the second subset associated with the CG. For example, the base station can transmit a message to the UE that includes an indication of which PUSCH opportunities are included in the second subset and skip all of the PUSCH opportunities in the second subset. This process can be used when the base station has configured the UE for fixed partitioning.

In another example, the base station can transmit a message to the UE to use each spare PUSCH opportunity, even if the UE has no data to transmit. If the UE has data to transmit, the UE can use the PUSCH resources to transmit the data. If the UE has no data to transmit, the UE can, for example, generate dummy MAC PDUs and use the PUSCH resources to transmit the dummy MAC PDUs.

In yet another example, the base station can send a message to the UE to select a HARQ PID for the spare PUSCH opportunities. In this situation, the UE can select HARQ PIDs for using the spare PUSCH opportunities for a new purpose from the intended purpose of the PUSCH opportunities of the first subset. The new purpose can be, for example, perform a retransmission/repetition of a previously transmitted transport block (TB), perform an autonomous transmission of a previously de-prioritized TB, or perform a new initial transmission or other new purpose. As an example, the base station can configure the UE to repeat a TB using the PUSCHs in the second subset, possibly with different redundant versions (RVs).

The base station can further dynamically change the UE's behavior as to how to handle spare PUSCHs, for example, using a MAC CE or downlink control information (DCI). For example, the base station can configure the UE as described in any of the above examples. The base station can then use a MAC CE or DCI to change how the UE handles the spare PUSCH.

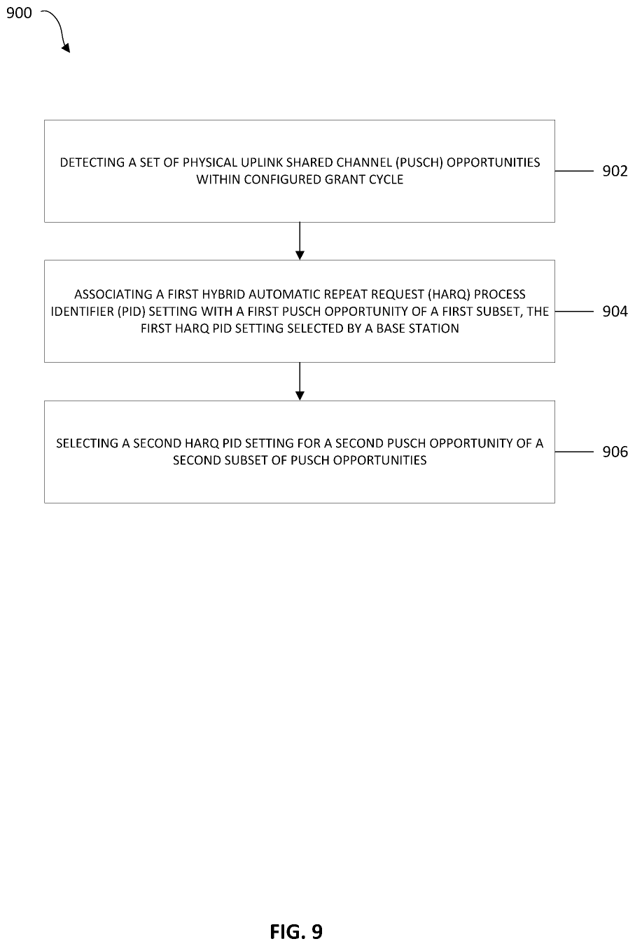

FIG. 9 is a process flow 900 for selecting a HARQ PID setting, according to one or more embodiments. At 902, the method can include a computing device detecting a set of PUSCH opportunities within a configured grant cycle. The computing device can be a UE that has been configured, by a base station using the CG, with resources for the set of PUSCH opportunities.

At 904, the method can include the computing device associating a first HARQ PID setting with a first PUSCH opportunity of a first subset of the set of PUSCH opportunities, the first HARQ PID setting configured by a base station. The set of PUSCH opportunities can be partitioned into a first subset and a second subset of PUSCH opportunities.

In some embodiments, the partitioning can be a fixed partitioning, where the base station transmits an indication to the UE as to how the set of PUSCH opportunities is to be partitioned. In some embodiments, the partitioning is based on a technical standard. For example, for a set of PUSCH opportunities with N number of PUSCH opportunities, the base station can transmit an indication that X-number of PUSCH opportunities are included in the first subset and Y-number of opportunities are included in the second subset, where X+Y=N. The base station can further select the HARQ PID settings for the PUSCH opportunities of the first subset. The base station can configure the UE with resources using a CG or a multi-PUSCH DG.

In some embodiments, the first PUSCH opportunity of the HARQ PID setting of the first subset is statically selected such that the UE can perform a new transmission using the first PUSCH opportunity. In other words, the HARQ PID corresponds to a new transmission and not a repeat of a previous transmission.

In some embodiments, where the base station uses fixed partitioning, the base station sets a number of PUSCH opportunities in a first CG cycle to different than a number of PUSCH opportunities in a second CG cycle. For example, the base station can set P-number of PUSCH opportunities for the first subset in a CG cycle. The base station can further set O-number of PUSCH opportunities for the first subset in a subsequent CG cycle.

In some other embodiments, the partitioning can be a dynamic partitioning, where the UE determines which PUSCH opportunities are included in the first subset and which PUSCH opportunities are included in the second subset. For example, the UE can transmit an uplink message using resources allocated for a PUSCH opportunity of the first subset and using an LCH. The UE can further determine that a buffer of an LCH is empty, the buffer being empty based on the transmission. The UE can further detect a spare PUSCH opportunity from the set of PUSCH opportunities. The UE can even further associate the spare PUSCH opportunity with the second subset of the set of PUSCH opportunities, wherein the spare PUSCH opportunity is the second PUSCH opportunity.

In some embodiments, the base station allocates the resources for the set of PUSCH opportunities using a DG allocated in DCI. In these instances, the DCI can further indicate whether the UE is to use a fixed partitioning or a dynamic partitioning.

At 906, the method can include the computing device selecting a second HARQ PID setting for a second PUSCH opportunity of a second subset of the set of PUSCH opportunities. The selection of the HARQ PID setting can be based on an intended purpose of the uplink transmission at the second PUSCH opportunity. In some embodiments, the UE selects the second HARQ PID from a pool of allowed HARQ PIDs, wherein the UE is configured with the pool of allowed HARQ PIDs by the base station. The base station can configure the UE with the pool of allowed HARQ PIDs, using a parameter of a radio resource control (RRC) message. The UE can further select the HARQ PID setting.

In some embodiments, the base station can configure the UE to perform direct partitioning or dynamic partitioning for two or more consecutive CG cycles. For example, the base station can configure the UE for direct partitioning for A-number of CG cycles followed by dynamic partitioning for B-number of CG cycles, where A and B are each greater than 1.

The computing device can transmit data to the base station using the second PUSCH opportunity. The base station can perform a HARQ process based on the selected second HARQ PID setting and return a HARQ response to the UE.

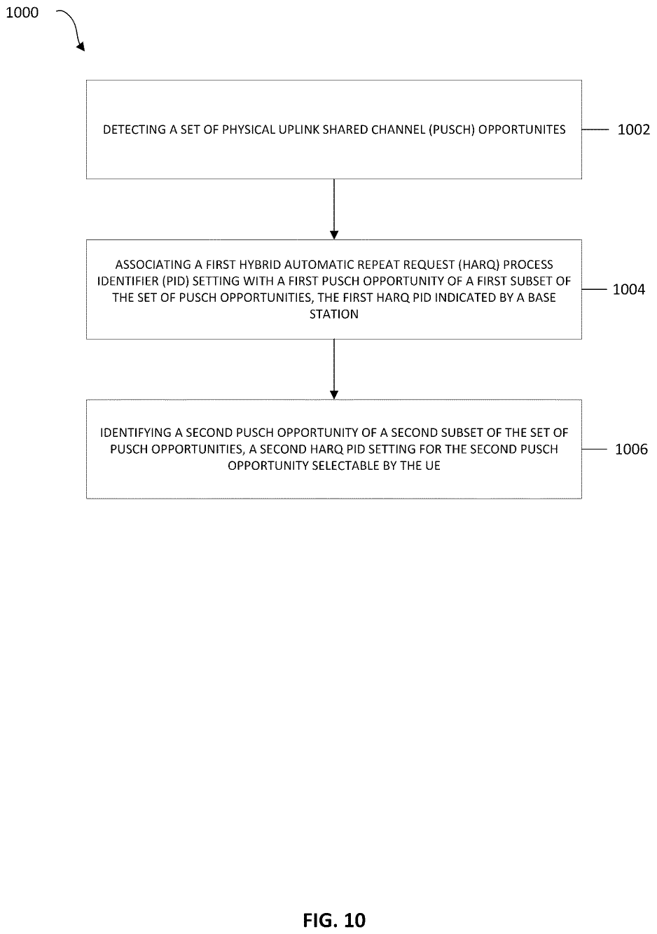

FIG. 10 is a process flow 1000 for a UE selecting a HARQ PID setting, according to one or more embodiments. At 1002, the method can include a computing device detecting a set of physical uplink shared channel (PUSCH) opportunities. The computing device can be a UE including memory and processing circuitry coupled with the memory.

At 1004, the method can include the computing device associating a first hybrid automatic repeat request (HARQ) process identifier (PID) setting with a first PUSCH opportunity of a first subset of the set of PUSCH opportunities, the first HARQ PID setting indicated by a base station. The set of PUSCH opportunities can be partitioned into a first subset and a second subset of PUSCH opportunities.

At 1006, the method can include the computing device identifying a second PUSCH opportunity of a second subset of the set of PUSCH opportunities, a second HARQ PID setting for the second PUSCH opportunity selectable by the UE. The UE can select the appropriate HARQ ID.

The computing device can transmit an indication associated with the second PUSCH opportunity to the base station. The indication can include whether the UE is going to use the second PUSCH opportunity for a purpose that is different from a purpose of the first PUSCH opportunity; an identity of the second PUSCH opportunity, or a respective HARQ PID for each PUSCH opportunity of the second subset including the second PUSCH opportunity. The indication is transmitted using UCI, CG-UCI, or a MAC CE

In some embodiments, the indication can be transmitted using CG-UCI, wherein the UE transmits the CG-UCI at a first PUSCH opportunity of the set of PUSCH opportunities, and wherein the CG-UCI indicates the respective HARQ PIDs for each PUSCH opportunity of the set of PUSCH opportunities that are being partitioned into the first subset and the second subset.

In some embodiments, the indication can be transmitted using CG-UCI, and wherein the CG-UCI indicates the UE is going to use or skip use of any PUSCH resources associated with the second subset.

In some embodiments, the indication can be transmitted using CG-UCI, wherein the UE transmits the CG-UCI at the second PUSCH opportunity, and wherein the CG-UCI indicates a HARQ ID for the second PUSCH opportunity.

In some embodiments, the set of PUSCH opportunities can be partitioned into the first subset and the second subset is based on a fixed partitioning, and wherein the UE is configured to not transmit CG-UCI in any PUSCH opportunity of the first subset, including the first PUSCH opportunity.

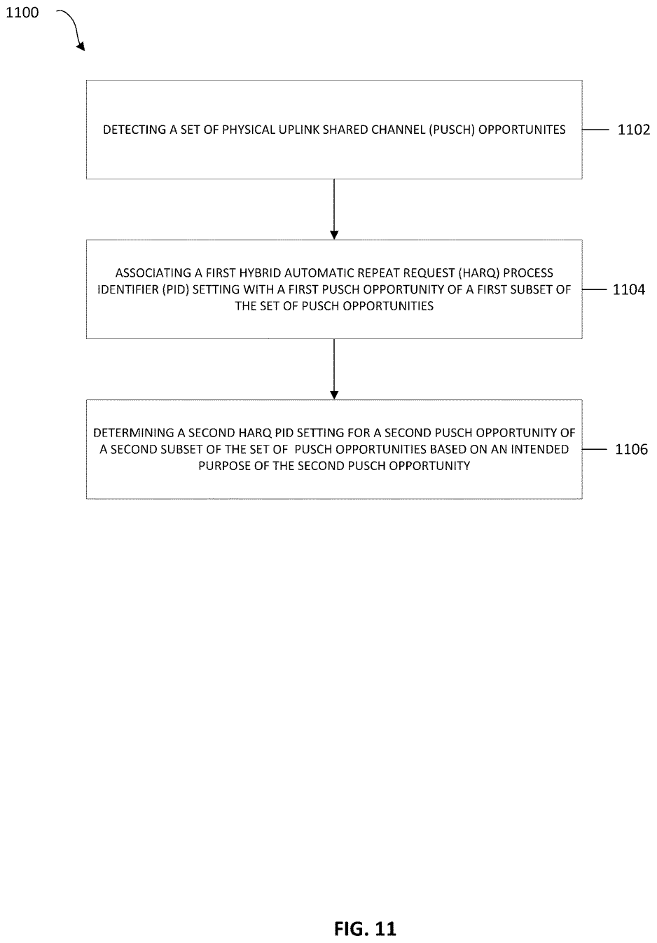

FIG. 11 is a process flow 1100 for a UE selecting a HARQ PID setting, according to one or more embodiments. At 1102, the method can include a computing device detecting a set of physical uplink shared channel (PUSCH) opportunities within a configured grant cycle. The computing device can be a UE including memory and processing circuitry coupled with the memory.

At 1104, the method can include the computing device associating a first HARQ PID setting with a first PUSCH opportunity of a first subset of the set of PUSCH opportunities.

At 1106, the method can include the computing device selecting a second HARQ PID setting for a second PUSCH opportunity of a second subset of the set of PUSCH opportunities based on an intended purpose of the second PUSCH opportunity.

In some embodiments, the UE can select the second HARQ PID setting based on being a same HARQ PID of an earlier PUSCH opportunity in the CG cycle, and wherein the intended purpose is to repeat transmission of a data block transmitted at the earlier PUSCH opportunity.

In some embodiments, the UE can select the second HARQ PID setting for the PUSCH opportunity based on being a same HARQ PID of an earlier PUSCH opportunity, wherein a CG timer associated with the same HARQ PID is running, and wherein the intended purpose is to retransmit a data block transmitted at the earlier PUSCH opportunity.

In some embodiments, the UE can select the second HARQ PID setting based on being a same HARQ PID of an earlier PUSCH opportunity, wherein a CG timer associated with the same HARQ PID is not running, and wherein instructions that, when executed by one or more processors, and wherein the intended purpose to transmit a data block at the second PUSCH opportunity for an alternate purpose than a data block transmitted at the first PUSCH opportunity.

In some embodiments, the UE can select the second HARQ PID setting based on being a same HARQ PID of an earlier PUSCH opportunity, and wherein the intended purpose is to autonomously transmit a de-prioritized MAC PDU.

In some embodiments, the UE can select the second HARQ PID for the PUSCH opportunity based on a MAC PDU with a highest priority LCH.

The computing device can transmit an uplink transmission to the base station using the second PUSCH opportunity.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted.” Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

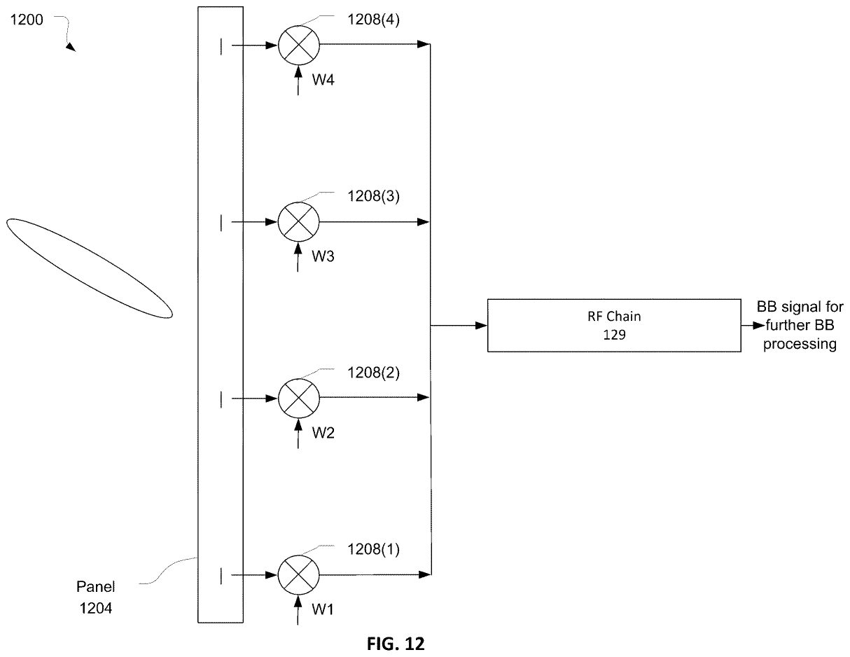

FIG. 12 illustrates receive components 1200 of the UE 1206, in accordance with some embodiments. The receive components 1200 may include an antenna panel 1204 that includes a number of antenna elements. The panel 1204 is shown with four antenna elements, but other embodiments may include other numbers.

The antenna panel 1204 may be coupled to analog beamforming (BF) components that include a number of phase shifters 1208(1)-1208(4). The phase shifters 1208(1)-1208(4) may be coupled with a radio-frequency (RF) chain 1212. The RF chain 1212 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1208(1)-1208(4) to provide a receive beam at the antenna panel 1204. These BF weights may be determined based on the channel-based beamforming.

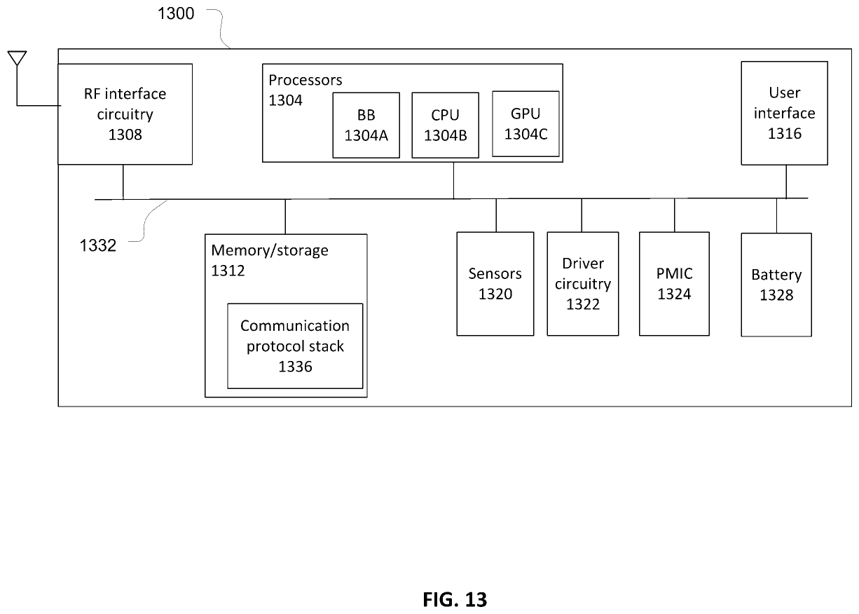

FIG. 13 illustrates a UE 1300, in accordance with some embodiments. The UE 1300 may be similar to and substantially interchangeable with UE 1206 of FIG. 12.

Similar to that described above with respect to UE 1300, the UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1300 may include processors 1304, RF interface circuitry 1308, memory/storage 1312, user interface 1316, sensors 1320, driver circuitry 1322, power management integrated circuit (PMIC) 1324, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1304A may also access group information 1324 from memory/storage 1312 to determine search space groups in which a number of repetitions of a PDCCH may be transmitted.

The memory/storage 1312 may include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1324 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1324.

In various embodiments, the RF interface circuitry 1308 may be configured to transmit/receive signals in a manner compatible with NR access technologies.

The antenna 1324 may include a number of antenna elements that each convert electrical signals into radio waves to travel through the air and to convert received radio waves into electrical signals. The antenna elements may be arranged into one or more antenna panels. The antenna 1324 may have antenna panels that are omnidirectional, directional, or a combination thereof to enable beamforming and multiple input, multiple output communications. The antenna 1324 may include microstrip antennas, printed antennas fabricated on the surface of one or more printed circuit boards, patch antennas, phased array antennas, etc. The antenna 1324 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC_Idle state, where it disconnects from the network and does not perform operations such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted deployed in a fixed location, and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

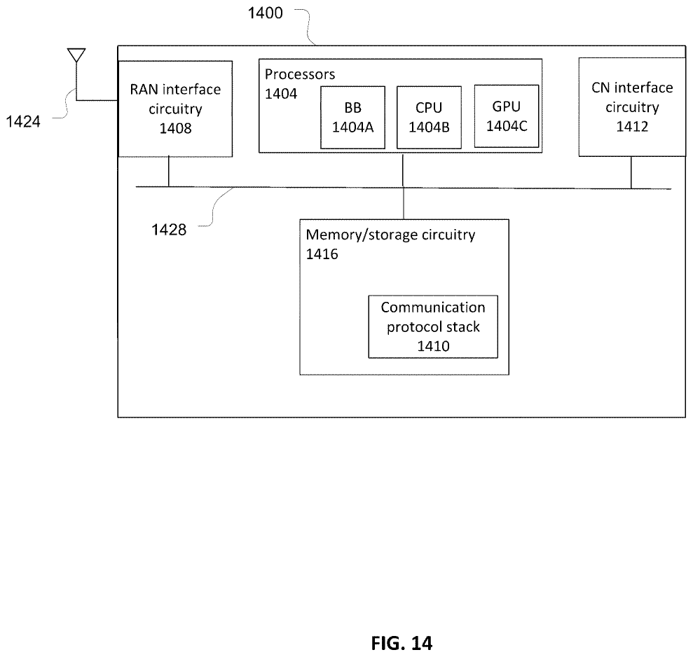

FIG. 14 illustrates a gNB 1400, in accordance with some embodiments. The gNB node 1400 may be similar to and substantially interchangeable with the base stations 144, 146 of FIG. 1.

The gNB 1400 may include processors 1404, RF interface circuitry 1408, core network (CN) interface circuitry 1412, and memory/storage circuitry 1416.

The components of the gNB 1400 may be coupled with various other components over one or more interconnects 1428.

The processors 1404, RF interface circuitry 1408, memory/storage circuitry 1416 (including communication protocol stack 1410), antenna 1424, and interconnects 1428 may be similar to like-named elements shown and described with respect to FIG. 12.

The CN interface circuitry 1412 may provide connectivity to a core network, for example, a 4th Generation Core network (5GC) using a 4GC-compatible network interface protocol such as carrier Ethernet protocols, or some other suitable protocol. Network connectivity may be provided to/from the gNB 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further example embodiments are provided.

Example 1 includes method, implemented by a UE, the method comprising: detecting a set of PUSCH opportunities within a configured grant cycle; associating a first HARQ PID setting with a first PUSCH opportunity of a first subset of the set of PUSCH opportunities, the first HARQ PID setting configured by a base station; and selecting a second HARQ PID setting for a second PUSCH opportunity of a second subset of the set of PUSCH opportunities.

Example 2 includes the method of example 1, wherein the first subset is configured by a network, and wherein the second subset is configured by the network.

Example 3 includes the method of example 1 or 2, wherein the first subset is fixed by a specification, and wherein the second subset is fixed by a specification.

Example 4 incudes the method of any of examples 1-3, wherein the method further includes: transmitting a TB containing data from a set of LCHs using resources allocated for a PUSCH opportunity of the first subset; determining that a buffer of the set of LCHs is empty based on the transmission; detecting a spare PUSCH opportunity from the set of PUSCH opportunities; and associating the spare PUSCH opportunity with the second subset of the set of PUSCH opportunities, wherein the spare PUSCH opportunity is the second PUSCH opportunity.

Example 5 incudes the method of any of examples 1-4, wherein resources are allocated for the set of PUSCH opportunities based on a CG or based on a multi-PUSCH DG.

Example 6 incudes the method of any of examples 1-5, wherein the first HARQ PID setting is a static configuration by the base station to enable the UE to perform a new transmission.

Example 7 incudes the method of any of examples 1-6, wherein selecting the second HARQ PID for includes selecting the second HARQ PID from a pool of allowed HARQ PIDs, wherein the UE is configured with the pool of allowed HARQ PIDs by the base station.

Example 8 incudes the method of example 7, wherein the UE is configured with the pool of allowed HARQ PIDs by a base station using a RRC parameter.

Example 9 incudes the method of any of examples 1-8, wherein resources are allocated for the set of PUSCH opportunities based on a dynamic grant (DG) allocated in a downlink control information (DCI), and wherein the DCI further indicates whether the UE is to use a fixed partitioning or a dynamic partitioning.

Example 10 incudes the method of example 1 wherein the UE uses a fixed partitioning, and wherein a number of PUSCH opportunities in a first CG cycle is different than a number of PUSCH opportunities in a second CG cycle.

Example 11 incudes the method of example 1, wherein the UE is configured to use fixed partitioning or a dynamic partitioning for two or more consecutive cycles

Example 12 includes one or more computer-readable media having stored thereon a sequence of instructions which, when executed, causes a processor to perform operations including a method described in or related to examples 1-11.

Example 13 includes a device comprising memory; processing circuitry, coupled with the memory, to perform one or more elements of a method described in or related to examples 1-11.

Example 14 includes a UE, comprising: memory; processing circuitry, coupled with the memory, to: detect a set of PUSCH opportunities; associate a first HARQ PID setting with a first PUSCH opportunity of a first subset of the set of PUSCH opportunities, the first HARQ PID setting configured by a base station; and identify a second PUSCH opportunity of a second subset of the set of PUSCH opportunities, a second HARQ PID setting for the second PUSCH opportunity selectable by the UE.

Example 15 includes the UE of example 14, wherein the processing circuitry further to: transmit, to a base station, an indication associated with the second PUSCH, wherein the indication includes whether the UE is going to use the second PUSCH opportunity for a purpose that is different from a purpose of the first PUSCH opportunity; an identity of the second PUSCH opportunity, or a respective HARQ PID for each PUSCH opportunity of the second subset including the second PUSCH opportunity.

Example 16 includes the UE of example 14 or 15, wherein the indication is transmitted UCI, CG-UCI, or a MAC CE.

Example 17 includes the UE of example 14 or 15, wherein the indication is transmitted using CG-UCI, wherein the UE transmits the CG-UCI at a first PUSCH opportunity of the set of PUSCH opportunities, and wherein the CG-UCI indicates the respective HARQ PIDs for each PUSCH opportunity of the set of PUSCH opportunities that are being partitioned into the first subset and the second subset.

Example 18 includes the UE of example 14 or 15, wherein the indication is transmitted using CG-UCI, and wherein the CG-UCI indicates the UE is going to use or skip use of any PUSCH resources associated with the second subset.

Example 19 includes the UE of example 14 or 15, wherein the indication is transmitted using CG-UCI, wherein the UE transmits the CG-UCI at the second PUSCH opportunity, and wherein the CG-UCI indicates a HARQ ID for the second PUSCH opportunity.

Example 20 includes the UE of any of examples 14-19, wherein the set of PUSCH opportunities are partitioned into the first subset and the second subset is based on a fixed partitioning, and wherein the UE is configured to not transmit CG-UCI in any PUSCH opportunity of the first subset, including the first PUSCH opportunity.

Example 21 includes one or more computer-readable media having stored thereon a sequence of instructions which, when executed, causes a processor to perform operations including the steps described in or related to examples 14-19.

Example 22 includes a method, performed by a device, to perform one or more elements of the steps described in or related to examples 14-19.

Example 23 includes one or more non-transitory computer-readable media including stored thereon instructions that, when executed by one or more processors, cause a UE to: detect a set of PUSCH opportunities within a configured grant cycle; associate a first hybrid automatic repeat request HARQ PID setting with a first PUSCH opportunity of a first subset of the set of PUSCH opportunities; and select a second HARQ PID setting for a second PUSCH opportunity of a second subset of the set of PUSCH opportunities based on an intended purpose of the second PUSCH opportunity.

Example 24 includes one or more non-transitory computer-readable media of example 23, wherein UE selects the second HARQ PID setting based on being a same HARQ PID of an earlier PUSCH opportunity in the CG cycle, and wherein the intended purpose is to repeat transmission of a data block transmitted at the earlier PUSCH opportunity/

Example 25 includes one or more non-transitory computer-readable media of example 23, wherein UE selects the second HARQ PID setting for the PUSCH opportunity in the second subset is selected based on being a same HARQ PID of an earlier PUSCH opportunity, wherein a CG timer associated with the same HARQ PID is running, and wherein the intended purpose is to retransmit a data block transmitted at the earlier PUSCH opportunity.

Example 26 includes one or more non-transitory computer-readable media of example 23, wherein the UE selects the second HARQ PID setting based on being a same HARQ PID of an earlier PUSCH opportunity, wherein a CG timer associated with the same HARQ PID is not running, and wherein instructions that, when executed by one or more processors, and wherein the intended purpose to transmit a data block at the second PUSCH opportunity for an alternate purpose than a data block transmitted at the first PUSCH opportunity.

Example 27 includes one or more non-transitory computer-readable media of example 23, wherein the UE selects the second HARQ PID setting based on being a same HARQ PID of an earlier PUSCH opportunity, and wherein the intended purpose is to autonomously transmit a de-prioritized MAC PDU.

Example 28 includes one or more non-transitory computer-readable media of example 23, wherein the UE selects the second HARQ PID for the PUSCH opportunity based on a MAC PDU with a highest priority LCH.

Example 29 includes a device comprising memory; processing circuitry, coupled with the memory, to perform one or more elements of a method described in or related to examples 23-28.

Example 30 includes a method, performed by a device, to perform one or more elements of the steps described in or related to example 23-28.

Example 31, includes a base station, comprising: one or more processors; a communication interface; radio frequency (RF) interface circuitry; and one or more computer-readable media including instructions that, when executed by the one or more processors, cause the base station to: transmit, using a multi-PUSCH CG, a message to a UE regarding a purpose of a spare PUSCH opportunity of a set of PUSCH opportunities; receive an uplink transmission from the UE, the uplink transmission transmitted using a resource allocated by the CG; and perform a HARQ for the uplink transmission, a HARQ PID setting selected by the UE.

Example 32 includes the base station of example 31, wherein the message includes a first indication of an identity of the spare PUSCH and a second indication to skip the identified spare PUSCH.

Example 33 includes the base station of example 31, wherein the message includes a first indication to use the spare PUSCH, and a second indication to use a dummy MAC PDU in the event that a buffer of a LCH is empty.

Example 34 includes the base station of example 31, wherein the message includes a first indication to select a HARQ PID for the spare PUSCH opportunity.

Example 35 includes the base station of example 31, wherein the message includes a MAC CE or DCI, and wherein the message includes an indication for the UE to change behavior regarding the spare PUSCH opportunity.

Example 36 includes one or more computer-readable media having stored thereon a sequence of instructions which, when executed, causes a processor to perform operations including the steps described in or related to examples 31-35.

Example 37 includes a method, performed by a device, to perform one or more elements of the steps described in or related to examples 31-35.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
detecting a set of physical uplink shared channel (PUSCH) opportunities within a configured grant cycle;
associating a first hybrid automatic repeat request (HARQ) process identifier (PID) setting with a first PUSCH opportunity of a first subset of the set of PUSCH opportunities, the first HARQ PID setting configured by a base station; and
selecting a second HARQ PID setting for a second PUSCH opportunity of a second subset of the set of PUSCH opportunities.

2. The method of claim 1, wherein the first subset is configured by a network or fixed by a specification, and the second subset is configured by the network or fixed by a specification.

3. (canceled)

4. The method of claim 1, wherein the method further includes:
transmitting a transport block (TB) containing data from a set of logical channels (LCHs) using resources allocated for a PUSCH opportunity of the first subset;
determining that a buffer of the set of LCHs is empty based on the transmission;
detecting a spare PUSCH opportunity from the set of PUSCH opportunities; and
associating the spare PUSCH opportunity with the second subset of the set of PUSCH opportunities, wherein the spare PUSCH opportunity is the second PUSCH opportunity.

5. The method of claim 1, wherein resources are allocated for the set of PUSCH opportunities based on a configured grant (CG) or based on a multi-PUSCH dynamic grant (DG).

6. The method of claim 1, wherein the first HARQ PID setting is a static configuration by the base station to enable the UE to perform a new transmission.

7. The method of claim 1, wherein selecting the second HARQ PID includes selecting the second HARQ PID from a pool of allowed HARQ PIDs, wherein the UE is configured with the pool of allowed HARQ PIDs by the base station.

8. The method of claim 1, wherein resources are allocated for the set of PUSCH opportunities based on a dynamic grant (DG) allocated in a downlink control information (DCI), and wherein the DCI further indicates whether the UE is to use a fixed partitioning or a dynamic partitioning.

9. The method of claim 1, wherein the UE uses a fixed partitioning, and wherein a number of PUSCH opportunities in a first CG cycle is different than a number of PUSCH opportunities in a second CG cycle.

10. An apparatus, comprising:
processing circuitry to:
detect a set of physical uplink shared channel (PUSCH) opportunities;
associate a first hybrid automatic repeat request (HARQ) process identifier (PID) setting with a first PUSCH opportunity of a first subset of the set of PUSCH opportunities, the first HARQ PID setting configured by a base station; and
identify a second PUSCH opportunity of a second subset of the set of PUSCH opportunities, a second HARQ PID setting for the second PUSCH opportunity selectable by the UE; and
interface circuitry, coupled to the processor circuitry, to enable communication.

11. The apparatus of claim 10, wherein the processing circuitry further to:
output for transmission, to a base station, an indication associated with the second PUSCH, wherein the indication includes whether the UE is going to use the second PUSCH opportunity for a purpose that is different from a purpose of the first PUSCH opportunity; an identity of the second PUSCH opportunity, or a respective HARQ PID for each PUSCH opportunity of the second subset including the second PUSCH opportunity.

12. The apparatus of claim 11, wherein the indication is transmitted using CG uplink control information (CG-UCI), wherein the UE transmits the CG-UCI at a first PUSCH opportunity of the set of PUSCH opportunities, and wherein the CG-UCI indicates the respective HARQ PIDs for each PUSCH opportunity of the set of PUSCH opportunities that are being partitioned into the first subset and the second subset.

13. The apparatus of claim 11, wherein the indication is transmitted using CG-UCI, and wherein the CG-UCI indicates the UE is going to use or skip use of any PUSCH resources associated with the second subset.

14. The apparatus of claim 11, wherein the indication is transmitted using CG-UCI, wherein the UE transmits the CG-UCI at the second PUSCH opportunity, and wherein the CG-UCI indicates a HARQ ID for the second PUSCH opportunity.

15. The apparatus of claim 10, wherein the set of PUSCH opportunities are partitioned into the first subset and the second subset is based on a fixed partitioning, and wherein the UE is configured to not transmit CG-UCI in any PUSCH opportunity of the first subset, including the first PUSCH opportunity.

16. One or more non-transitory computer-readable media including stored thereon instructions that, when executed by one or more processors, cause the one or more processors to:
detect a set of physical uplink shared channel (PUSCH) opportunities within a configured grant cycle;
associate a first hybrid automatic repeat request (HARQ) process identifier (PID) setting with a first PUSCH opportunity of a first subset of the set of PUSCH opportunities; and
select a second HARQ PID setting for a second PUSCH opportunity of a second subset of the set of PUSCH opportunities based on an intended purpose of the second PUSCH opportunity.

17. The one or more non-transitory computer-readable media of claim 16, wherein the selection of the second HARQ PID setting is based on being a same HARQ PID of an earlier PUSCH opportunity in the CG cycle, and wherein the intended purpose is to repeat transmission of a data block transmitted at the earlier PUSCH opportunity.

18. The one or more non-transitory computer-readable media of claim 16, wherein the selection of the second HARQ PID setting for the PUSCH opportunity in the second subset is selected based on being a same HARQ PID of an earlier PUSCH opportunity, wherein a CG timer associated with the same HARQ PID is running, and wherein the intended purpose is to retransmit a data block transmitted at the earlier PUSCH opportunity.

19. The one or more non-transitory computer-readable media of claim 16, wherein the selection of the second HARQ PID setting is based on being a same HARQ PID of an earlier PUSCH opportunity, wherein a CG timer associated with the same HARQ PID is not running, and wherein instructions that, when executed by one or more processors, and wherein the intended purpose to transmit a data block at the second PUSCH opportunity for an alternate purpose than a data block transmitted at the first PUSCH opportunity.

20. The one or more non-transitory computer-readable media of claim 16, wherein the selection of the second HARQ PID setting is based on being a same HARQ PID of an earlier PUSCH opportunity, and wherein the intended purpose is to autonomously transmit a de-prioritized medium access control protocol data unit (MAC PDU).

21. The one or more non-transitory computer-readable media of claim 16, wherein the selection of the second HARQ PID for the PUSCH opportunity is based on a MAC PDU with a highest priority logical channel (LCH).

22. (canceled)

23. (canceled)

24. (canceled)

25. (canceled)
